(19) United States
(12) Patent Application Publication
(10) Pub. No.: US 2024/0208007 A1
(43) Pub. Date: Jun. 27, 2024

(54) HAND-HELD CO-EXTRUDED FINISHING SANDING BLOCK

(71) Applicant: Trade Associates, Inc., Kent, WA (US)

(72) Inventors: William N. Turnbull, Kent, WA (US); Peter J. Lamb, West Gosford (AU)

(73) Assignee: Trade Associates, Inc., Kent, WA (US)

(21) Appl. No.: 18/573,009

(22) PCT Filed: Oct. 19, 2021
(86) PCT No.: PCT/US2021/055530

§ 371 Date: Dec. 21, 2023

Related U.S. Application Data
(60) Provisional application No. 63/105,136, filed on Oct. 23, 2020.

(51) Int. Cl. B24D 15/02

(52) U.S. Cl. CPC B24D 15/02

(57) ABSTRACT

A sanding block produced by co-extrusion of a substantially softer polymeric material and a substantially harder polymeric material is described. The substantially hollow interior of the co-extruded body of the sanding block may be sealed by first and second plugs that seal the opposite longitudinal ends of the hollow sanding block section to enable drawing suction through the sanding block, such as for use with a vacuum device.

### CROSS-REFERENCE TO RELATED APPLICATION

This application claims the benefit of U.S. Provisional Application No. 63/103,136, filed Oct. 23, 2020, which is incorporated by reference herein in its entirety and for all purposes.

### FIELD

The present disclosure relates generally to sanding blocks and methods for manufacturing the same.

### BACKGROUND

A sanding block is a block used to hold sandpaper. In its simplest form, a sanding block is made of wood or cork with one smooth flat side against which the sandpaper is held. Sanding blocks are helpful for reducing or preventing unevenness on the sanded surfaces (i.e. “waves”) that can occur when sanding using plain sandpaper. Typically, the sandpaper is wrapped around the flat side of the block and held in place by any suitable means, such as by a fitter cardboard in the simplest version or by clips, teeth or clamps, or other in more complex designs. Commercial sanding blocks have been made from various materials. Sanding blocks for some applications, such as the auto body industry, have been manufactured from Plexiglas, acrylonitrile butadiene styrene (ABS) and other materials. A persistent challenge in this industry, for example, is how to design a sanding block with a comfortable handle, yet provide a sufficiently smooth sanding surface to avoid “waves” while also reducing the risk of delamination of the sanding material when the sanding block conforms to various curves (e.g., contoured auto body surfaces) during use. Another challenge with existing sanding blocks for these types of application is the difficulty of producing a sanding block that meets the above needs but is also suitable for concurrent use with a vacuum unit, which is desirable for health and safety reasons. Thus, designer s and manufacturers of sanding blocks continue to seek improvements thereto.

### SUMMARY

A sanding block according to embodiments of the present disclosure includes a hollow handle body configured for an ergonomic fit in a user's hand, the hollow handle body having a substantially constant cross-section along a full length of the handle body. In some embodiments, the handle body is a unitary body that defines all but one of a plurality of circumferential walls of an internal cavity defined by the sanding block. The handle body is made, in some embodiments, from a first polymeric material. The sanding block further includes a base providing the one of the plurality of circumferential walls that encloses the internal cavity. The base is made, in some embodiments, from a second polymeric material different from than the first polymeric material, and the base has an externally facing surface that provides a smooth sanding surface of the sanding block. In preferred embodiments, the hollow handle body and the base are formed and joined together via a co-extrusion process.

In some embodiments, the cross-section of the hollow handle body is defined by an outer extrusion surface defining, in part, an exterior of the sanding block and an inner extrusion surface defining, in part, the internal cavity, the inner extrusion surface substantially corresponding in profile to the outer extrusion surface. In some embodiments, the handle body has a substantially constant thickness as defined between the outer extrusion surface and the inner extrusion surface. In some embodiments, the thickness of the handle body is greater than a thickness of the base. In some embodiments, the first polymeric material is softer than the second polymeric material. In some embodiments, the first polymeric material is a thermoplastic elastomer. In some embodiments, the second polymeric material is an acrylic. In some embodiments, the internal cavity is substantially sealed except for one or more inlet openings provided in the base, and one or more outlet openings provided in a handle formed at least in part by the handle body such that suction can be applied on the sanding block to draw air through the sanding block from the inlet to the outlet openings. In some embodiments, the sanding block further includes a first plug fixed to the handle body and base proximate and sealing a first longitudinal side of the sanding block and a second plug fixed to the handle body and base proximate and sealing a second longitudinal side of the sanding block, whereby the internal cavity is substantially fully enclosed.

A method of manufacturing a sanding block according to some embodiments of the present disclosure includes integrally forming a handle and a base, each formed of a different polymer having a different hardness, by co-extruding the different polymers to produce a substantially hollow sanding block. In some embodiments, the method further includes fixing a first end wall to a first open longitudinal end of the sanding block thereby sealing the first open longitudinal end and a second end wall to a second open longitudinal end of the sanding block, thereby sealing an internal cavity of the hollow sanding block. In some embodiments, the method further includes, drilling one or more inlet openings through the sanding surface and one or more outlet openings through a wall of the handle of the sanding block, whereby the internal cavity is provided in communication with ambient air. In some embodiments, the method further includes securing respective one or more hose fittings to the one or more outlet openings in the handle, and fixing (e.g., adhering) an abrasive layer to the sanding surface. In some embodiments, the producing of the substantially hollow sanding block includes provide a supply of a thermoplastic elastomer into a first hopper of an extrusion machine, provide a supply of a second polymer, which when cured is harder than the thermoplastic elastomer, into a second hopper of the extrusion machine, feed the thermoplastic elastomer material into a contoured (e.g., curved) portion of a die of the extrusion machine while concurrently feeding the second material into a substantially flat portion of the die to produce an extrusion comprising the thermoplastic elastomer and the second polymer. In some embodiments, the method further includes cutting the substantially extrusion into segments to produce a hollow body of a sanding block. In some embodiments, the extrusion is cut into segments, each having a length ranging between 4 inches and 20 inches.

A sanding block according to some embodiments of the present disclosure, includes a sanding block produced by any of the methods described herein, for example by a method involving the co-extrusion of two different polymers into a and extrusion where one side of the extrusion is formed of a first polymer and a second side of the extrusion, which is spaced from the first side by a cavity, is formed of a second polymer, which when cured is harder than the first polymer, and subsequently cutting the extrusion into segments of desired length to provide a plurality of hollow bodies for individual sanding blocks. A sanding block according to further embodiments of the present disclosure, includes a sanding block produced by simultaneously extruding, in a co-extrusion process, a first polymer and a second polymer which, when cured, is harder than the first polymer to produce an extrusion having a first wall formed of the first polymer and a second wall opposite the first wall and formed of the second polymer, the first and second walls spaced apart by a cavity defined therebetween during the co-extrusion process, the sanding block being further produced by cutting a segment from the extrusion and fixing an abrasive layer to an outer surface of the second wall.

This summary is provided to aid in understanding the present disclosure. Each of the various aspects and features of the disclosure may advantageously be used separately in some instances, or in combination with other aspects and features of the disclosure in other instances. Accordingly, while the disclosure is presented in terms of examples, individual aspects of any example can be claimed separately or in combination with aspects and features of that example or any other example. This summary is neither intended nor should it be construed as being representative of the full extent and scope of the present disclosure. The present disclosure is set forth in various levels of detail in this application and no limitation as to the scope of the claimed subject matter is intended by either the inclusion or non-inclusion of elements, components, or the like in this summary.

### BRIEF DESCRIPTION OF THE DRAWINGS

The accompanying drawings, which are incorporated in and constitute a part of the specification, illustrate examples of the disclosure and, together with the general description given above and the detailed description given below, serve to explain the principles of these examples.

FIG. 1 is a simplified illustration of a sanding block.

FIG. 2 is cross-sectional view of a co-extruded sanding block according to the present disclosure.

FIG. 3 is a simplified illustration of an extrusion machine.

FIG. 4A is a simplified longitudinal section view of a die for forming a co-extruded sanding block according to embodiments of the present disclosure.

FIG. 4B is a simplified transverse section view of the die, taken at section line 4B-4B, in FIG. 4A.

FIG. 5A is a simplified longitudinal section view of another die for forming a co-extruded sanding block according to embodiments of the present disclosure.

FIG. 5B is a simplified transverse section view of the die, taken at section line 5B-5B, in FIG. 5A.

FIG. 5C is another simplified transverse section view of the die, taken at section line 5C-5C, in FIG. 5A.

FIG. 6 is a flow diagram of a process for manufacturing a sanding block according to the present disclosure.

FIG. 7 is a flow diagram of a co-extrusion process for manufacturing a sanding block according to the present disclosure.

The drawings are not necessarily to scale. In certain instances, details unnecessary for understanding the disclosure or rendering other details difficult to perceive may have been omitted. In the appended drawings, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label. The claimed subject matter is not necessarily limited to the particular examples or arrangements illustrated herein.

### DETAILED DESCRIPTION

As described above, sanding blocks have been made from various materials such as Plexiglas, ABS and others to provide a sufficiently smooth sanding surface. However, such existing sanding blocks often suffer from the risk of delamination, may not be equipped with a comfortable handle, or if so equipped, their design maybe overly complex, increasing the cost of manufacture. One existing solution is to attach duct tape to the non-contact side of the sanding block's sanding surface to substitute for a handle. This, however, does not provide a secure hold on the block and must frequently renewed as the flexing action during the use of the block will cause it to come loose. In another existing design, the handle is formed as a separate component and is fixed to the sanding surface by use of countersunk screws inserted from the sanding surface into the handle to hold it in place. This solution has two problems: 1) a countersink hole must be created in the sanding surface which is undesirable, and 2) should the screw loosen it will dig into the finish/sanded work surface damaging or destroying it. Gluing the handle to the sanding surface has been tried but has failed due to the stress of the flex motion in conforming to the work surface. Thus, there remains a need for a sanding block that can address the shortcomings of existing solutions, while providing a commercially viable solution.

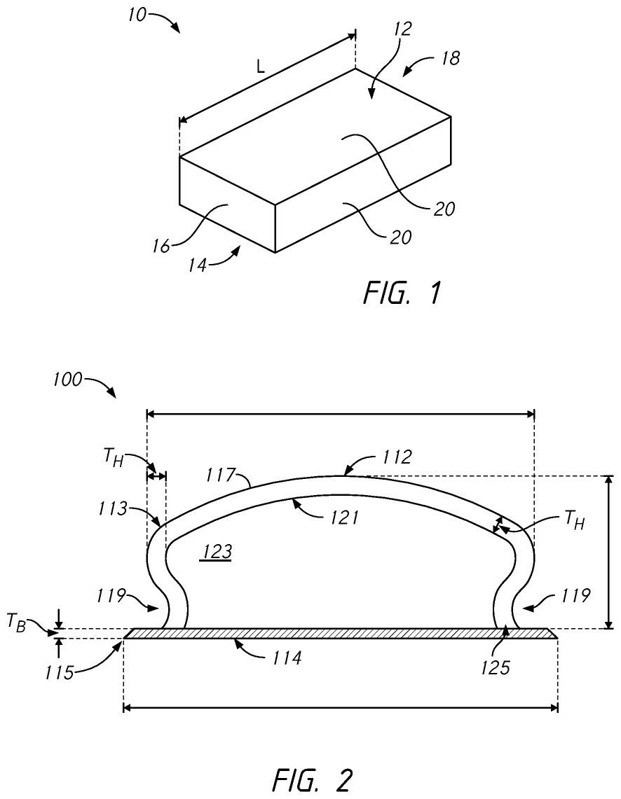

A sanding block 10, which for simplicity is shown in FIG. 1 as a substantially rectangular block, has a grip or handle portion 12 and a sanding surface 14 located on the opposite side of the sanding block 10 from the handle portion 12. Sand paper is retained to the sanding surface 14 via any suitable means. The sanding block 10 may have any suitable length L, extending between the first (e.g., front) side 16 and the opposite, second (e.g., rear) side 18 thereof, as may be desired for a particular application. Circumferential walls 20, extend between and connect the front and rear sides 16 and 18 of the sanding block 10. The sanding block may have a regular geometry (e.g., a rectangular prism, as shown) or may be differently shaped. For example, the sanding block may have an irregular cross-sectional shape that includes a contoured handle portion, as shown in FIG. 2.

A sanding block formed by co-extrusion of two different polymers. The handle of the sanding block may be formed by a first polymer, e.g., a relatively softer polymer as compared to the second polymer that provides the smooth sanding surface of the sanding block. In some embodiments the first polymer, when cured, is softer and/or has lower stiffness than the second polymer. The first polymer may be a thermoplastic elastomer, while the second polymer is a non-elastomer thermoplastic. Using co-extrusion, wherein the two different materials, one for the handle and one for the sanding surface, are merged during the extrusion process, can produce a superior product whereby the risk of delamination or separation of the two portions of the sanding block is effectively eliminated since the co-extruded handle and base result in a unitary body rather than a two-part block where components have been glued or otherwise joined after manufacture. A co-extruded sanding block can thus better withstand the flexing as the block is used. Moreover, the hollow interior of the sanding block lends itself to use with a vacuum unit. For the latter, the open ends of the extruded section are plugged with any suitable material, for example the same material as used for the handle, the base, or a different polymeric material. The plugs can be glued to the ends of the sanding block to fully enclose the internal cavity formed by the substantially hollow extrusion section, and thus enable drawing suction therethrough. Various materials may be used together in a co-extrusion process. For example, the handle portion may be made from any suitable relatively soft polymer, such as a thermoplastic elastomer (TPE), sometimes interchangeably referred to as thermoplastic rubber (TPR). TPR melds well with ABS or other acrylic and thus can be used in a co-extrusion process to produce a sanding block as described herein. Other suitable polymeric materials for the handle and/or base, e.g., which have similar or compatible flow characteristics, may be used.

FIG. 2 shows a cross-sectional view of a sanding block 100 produced by co-extrusion in accordance with the present disclosure. The sanding block 100 has a handle portion (or simply handle) 112, provided by the handle body 113, and a sanding surface 114 provided by the base 115. As shown in FIG. 2, the handle body 113 is a substantially hollow body, the exterior surface of which is configured for an ergonomic fit in a user's hand. For example, the upper side 117 of the handle body 113 may be curved outwardly so as to fit comfortably against the user's palm and fingers when curved for griping the handle 112. The handle body may include a inwardly curved (or concave) portion to receive the tips of the user's fingers when the user is gripping the sanding block. The handle body may include an inwardly curved portion 119 on one or both of the opposing sides of the handle 112. In the case of a handle having inwardly curved portions 119 on both of the opposing lateral sides of the handle, the profiles of the inwardly curved portions 119 may be substantially the same as shown in FIG. 2, which may provide for interchangeable (left or right hand) grip irrespective of the orientation of the handle. In some embodiments, the profiles of the inwardly curved portion 119 on one of the lateral sides may differ from that of the inwardly curved portion 119 on the other lateral side, which may tailor the sanding block for being gripped with a particular (left or right) hand in a particular orientation of the sanding block.

The hollow handle body 113, and more specifically the interior surface 121 thereof, defines, at least in part, an internal cavity 123. Because the handle body 113 and base 115 are formed by an extrusion process, the surfaces thereof may also be referred to as extrusion surfaces, and the internal cavity 123 extends the full length of the handle body 113. The handle body 113 and base 115 have a constant cross-section (e.g., as shown in FIG. 2) along the full length of the sanding block 100. In the example in FIG. 2, the thickness of the handle body (TH) and/or the thickness of the base (TB) may be subs nationally constant, excepting any variations in thickness resulting from normal tolerances and expected deviations due to the extrusion process and/or variations due to curvatures in the profile of the handle. In other words, as shown in the illustrated example, the distance between the inner surface 121 and the outer surface 117 may be substantially the same at any location along the contoured profiles thereof, and thus the inner surface 121 has a corresponding curvature or profile to that of the outer surface 117. In other embodiments, the inner surface 121 may have different profile from the outer surface 117 and thus the thickness of the handle body 113 may vary at different locations of the extrusion section. For example, a simplified internal profile, such as a semicircular or semi-oval profile, may be used for the inner surface 121. In other embodiments, the profiles of the inner and outer surfaces may be substantially the same along most of the length of the section but for the locations near the handle-base interface 125, where an increase in the thickness may be provided and which may facilitate a larger surface area of material melding and thus a stronger bond between the two dissimilar materials of the sanding block. Various other configurations may be used. It should also be noted that the dimensions shown in the example in FIG. 2 are merely exemplary, provided to illustrate the general scale and particular configuration of one example of a co-extruded sanding block. The dimensions of a sanding block according to the present disclosure are not limited to the ones illustrated. In preferred embodiments, the sanding block may have a length in the range of about 5″ to about 30″ with a width of about 2″ to about 6.8″, in some cases a width preferably between 2⅞″ and 4½″. In some embodiments, the width of the co-extruded sanding block may be selected to correspond to industry standard widths for sanding paper. The thickness of the handle material should be sufficient to offer both a solid grip as well as a comfortable grip. In embodiments configured for use with a vacuum unit, the thickness of the material forming the hollow body should be sufficient to provide a sufficiently sturdy structure that would not to cave in due to the vacuum pressure when used a vacuum unit. The thickness of the base (e.g., the more rigid, for example ABS, portion of the co-extrusion) may vary in different embodiments, depending on the desired flexibility of the sanding block. In some embodiments, the thickness of the base may range between ⅛″ and ⅜″ depending on the desired flexibility and the length of the sanding block. In some embodiments, the corners of the base may be rounded or tapered up from the work surface to reduce the risk of accidental damage to the work surface as may be caused by the user approaching the work piece from other then a flat angle and accidentally digging into the work surface with a sharp corner.

As can be seen in the exemplary section shown in FIG. 2, the hollow handle body 113 defines all but one of the circumferential walls of the sanding block 100. In other words, the inner extrusion surface 121 of the handle body 113 defines an open channel. The open side of the channel is enclosed by the inner surface 127 of the base 115, thereby produced the closed section of the sanding block 100 shown in FIG. 2. In other words, the base 115 defines the last circumferential wall of the internal cavity (or channel) 123 that encloses the internal cavity (or channel) 123. As noted, the geometry of the handle portion (e.g., the profile and/or thickness thereof) may be different in other embodiments of the invention. Similarly, in other embodiments, the geometry of the base, such as the geometry of the projecting ends of the base and/or the thickness, which may be constant or vary, of the base may differ from the example in FIG. 2, as long as a substantially smooth sanding surface 114 is provided by the outer surface of the base 115.

As previously noted, the handle body and the base are formed of two different polymeric materials. For example, the handle body, which is a unitary body, may be formed from a softer polymer, such as thermoplastic elastomer (TPE), sometimes interchangeably referred to as thermoplastic rubber (TPR). The base, also a unitary body, may formed from a stiffer or harder polymer such as Plexiglas or other acrylic, ABS, PVC or another suitable plastic, in order to provide a relatively smooth sanding surface. The base may thus be more rigid than the handle in order to provide the smooth sanding surface. In some embodiments, the base is made from a stiffer or harder material than the handle so as to be able to apply sufficient pressure against the work piece for sanding, while still having some flex to allow the sanding surface to follow a contoured surface of the work piece. The softer polymer handle and harder polymer base are formed and joined together into a unitary body by a co-extrusion process. In one embodiment, the sanding block 100 includes a handle body 113 formed of TPR co-extruded with a base 115 formed of ABS.

In some embodiments, the substantially hollow interior of the sanding block may be substantially sealed, such as by first and second end walls (or plugs) fixed to the opposite longitudinal ends of the sanding block 100. The plugs (not shown here) may be configured to fit within the profile defined by the inner surfaces of the handle body 113 and base 115 and may, in such instances, be fixed to the inner surfaces of the hollow section. In other embodiments, one or both of the end walls may span across the opening of the hollow section and may lie and/or be fixed to the end surfaces of the block. Sealing the opposite first and second longitudinal ends of the hollow block enables the sanding block to be used with a vacuum unit, which may be operatively connected to an outlet opening in the handle to draw air from one or more openings in the sanding surface 114, through the interior of the hollow block and out the outlet opening in the handle.

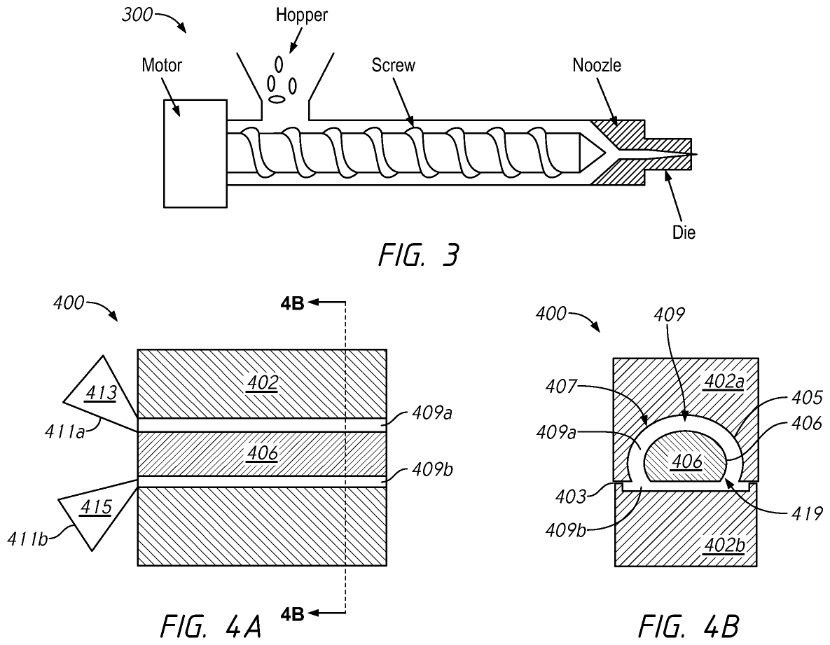

FIG. 3 shows an example of a portion of an extrusion machine 300 that can be used to extrude polymer materials. The extrusion machine 300 includes one or more nozzles that feed the melted polymer into the die. Each nozzle receives the melted polymer from a feed and drive portion of the machine 300, which may include an auger or screw positioned to rotate freely within a feed section and which may be driven by a motor or any other suitable means. The solid polymer material is fed into the feed channel, via a hopper, in any suitable form such as in the form of chips or pellets. The polymer is melted within the feed channel by heat applied thereto and optionally, further due to the motion of the screw. In the case of coextruding two dissimilar materials to form the hollow section of a sanding block, the extrusion machine includes at least two separate nozzles, each operatively connected to a feed and drive system that may be similar to the ones schematically illustrated in FIG. 2. As such, the extrusion machine feeds two different polymers, which may have different properties (e.g., one stiffer or harder than the other), into and out the distal end of the die to produce the co-extruded sanding block of the present disclosure. In some embodiments, the two different polymers may have comparable flow characteristics so that they flow substantially at a same rate through the die. In other embodiments, one of the polymers may have different flow characteristics. In such embodiments, the polymers may be fed at different rate through the feed section and/or at different locations of the die to facilitate a desired level of blending (e.g., substantially confining the melding or blending to the handle-base interface) to avoid excessive mixing of the two polymers in the die which may have unexpected or undesirable effects on the final extruded section.

FIGS. 4A and 4B show longitudinal and transverse simplified section views through an exemplary die 400 for co-extruding a sanding block (e.g., block 100) according to the present disclosure. The die 400 defines the extruded section's outer and inner profiles. For manufacturability, the ring 402 of the die 400 may be formed by multiple portions (e.g., first die portion 402a and second die portion 402b), which are joined together at the seam 403 to define the outer profile 405 of the extruded section 407. In this examples, since the section 407 produced by the co-extrusion process is hollow, the die 400 may also include a mandrel 406 positioned within the outer profile 405 defined by the die ring 402 and which defines the profile 406 of the internal cavity of the hollow sanding block (e.g., cavity 123 of sanding block 100). As a result, a die pattern 409 corresponding to the extruded section 407 includes an first (e.g., upper) portion 409a, which in this examples is contoured for an ergonomic fit in a user's hand, and a second (e.g., lower) portion 409b is formed.

The first (e.g., upper) portion 409a of the die pattern is fed by a first nozzle 411a supplying the softer polymer 413 (e.g., TPR) for forming the handle body (e.g., handle body 113) of the sanding block (e.g., sanding block 100). The second (e.g., lower) portion 409b of the die pattern is fed by a second nozzle 411b supplying the harder polymer 415 (e.g., ABS, another acrylic, or other polymer having similar flow characteristics as the first polymer 413) for forming the base (e.g., base 115) of the sanding block (e.g., sanding block 100). In this example, the lower portion 409b of the die pattern 409 provides a substantially flat profile, particularly along the outer extruded surface. The upper and lower portions 409a and 409b, respectively, of the die pattern 409 are in fluid communication along the handle-base interface 419 (e.g., interface 125 of sanding block 100) such that the softer polymer 413 can meld with the harder polymer 415 as the two polymers are forced and flow through the die 400. As the extruded section exits the die 400 and is provided in a cooling zone of the extrusion machine, the two polymers solidify and cure, produced a handle-base interface at which the two polymers have blended as part of the co-extrusion process and thus form a stronger bond than if the two polymers had been joined (e.g., adhered) after solidification/curing of the handle and base. After solidification and curing, the extruded section is cut to length, for example to any desired length ranging between 4-5 inches and about 12 inches, and in some cases longer than 12 inches in some cases up to 30 inches, to produce the individual sanding blocks. Each sanding block may then optionally be further processed by forming inlet and outlet openings, plugging the open ends of the cut sections, and securing hose fittings to the outlet openings for easy quick connect to a vacuum hose, before the sanding blocks are provided to a consumer for use.

In the example in FIGS. 4A and 4B, the die 400 may define a substantially constant section along its length. In such examples, the first and second nozzles 411a and 411b, respectively, may be configured to feed the two polymers substantially from the proximal end of the die 300. In other examples, one of the first and second nozzles 411a and 411b, respectively, may connect to an intermediate location along the length of the die 400 and thus one of the polymers (e.g., the softer polymer 413 or harder polymer 415) may be fed into and only through a distal portion of the die 400. The terms proximal and distal are defined with respect to the direction of flow, that is, proximal generally refers to an upstream location or direction and distal generally refers to a downstream location or direction.

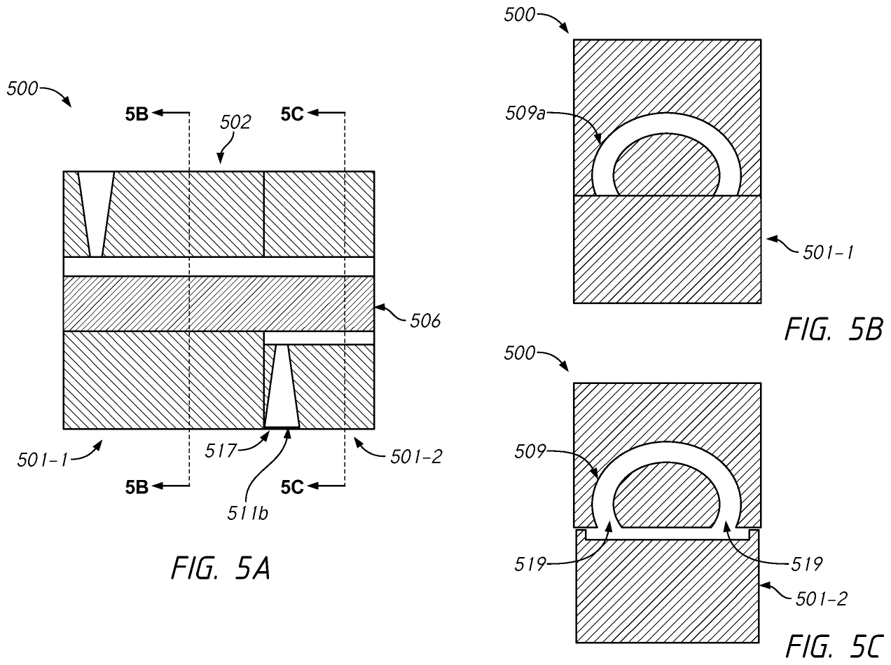

FIGS. 5A-5C show a longitudinal and two transverse simplified section views through another exemplary die 500 for co-extruding a sanding block (e.g., block 100) according to the present disclosure. In this example, the extrusion section defined by the die 500 changes along the length of the die. Here, a proximal end 501-1 of the die 500 defines a different (e.g., a partial) die pattern 509a as compared to the die pattern 509 defend by the distal end 500-2. Similar to the example in FIGS. 4A-4B, the die 500 may be formed from a plurality of portions (e.g., three or more portions including two portions for the die ring 502 and one for the mandrel 506). However, in this example, the configuration of lower portion (e.g., the cavities formed therein to form the die pattern) varies along the direction of flow. In the specific example in FIG. 5A, the lower portion of the die pattern 509 starts from an intermediate longitudinal location of the die ring 502, as shown by the two different cross-sections (in FIGS. 5B and 5C) taken at two different longitudinal locations of the die 500. Here, the second nozzle 511b is arranged to feed the second polymer at an intermediate longitudinal location 517 of the die 500. Such a configuration of the die may provide better control of the amount of polymer blending occurring at the interface and/or may be suitable for use with polymers that have greater dissimilarities in their flow characteristics. For example, by allowing the first polymer to at least partially form, as it is forced and flows through the proximal end 501-1 of the die 500, before introducing the second polymer, blending of the two polymers in the die 500 may be reduced and thus better confined to the interface 519, since blending would occur in the distal portion of the die 500. A configuration as shown in FIGS. 5A-5C may be useful for a combination of soft and hard polymers, one of which has a faster rate of solidification, the latter polymer being fed at the intermediate location 517 of the die.

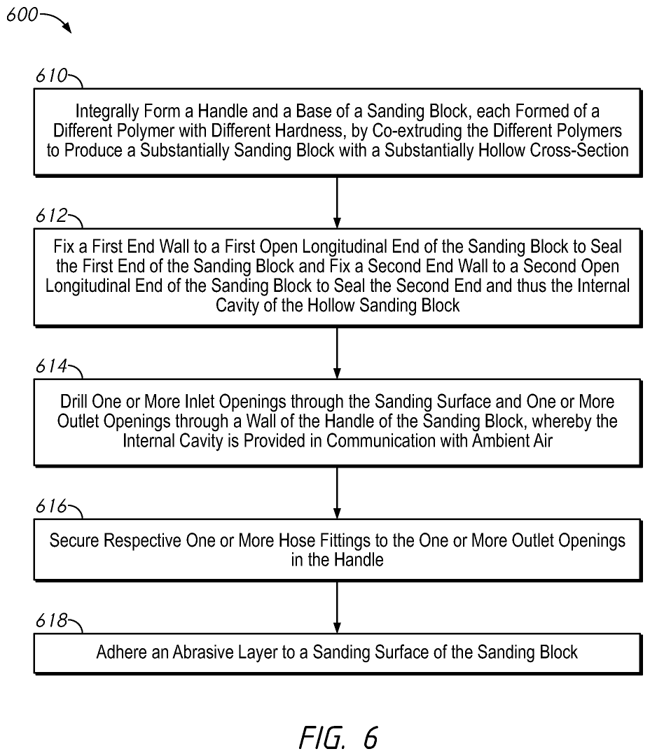

FIG. 6 shows a flow diagram of a process 600 for producing a sanding block (e.g., sanding block 100) according to some embodiments of the present disclosure. Step 610 of the process 600 includes integrally forming a handle and a base, each made from different polymers having different hardness, by co-extruding the two different polymers to produce a sanding block having a substantially hollow cross-section. The process 600 further includes fixing a first end wall to a first open longitudinal end of the sanding block to seal the first end of the sanding block and fixing a second end wall to a second open longitudinal end of the sanding block to seal the second end thereof, thereby sealing an internal cavity of the hollow sanding block, as shown at step 612.

One or more inlet openings through the sanding surface and one or more outlet openings through a wall of the handle of the sanding block are drilled as shown at step 614, whereby the internal cavity is provided in communication with ambient air to enable suction to be drawn from the sanding surface, through the sanding block, to a vacuum unit connected to the handle. To that end, one or more hose fittings may be secured to the respective one or more outlet openings in the handle, as shown at step 616. An abrasive layer (e.g., sand paper) is fixed (e.g., adhered or otherwise bonded) to the sanding surface, as shown at step 618, before the sanding block can be used by the end-user. For example, the abrasive layer (e.g., sand paper) may be fixed to the sanding surface using, e.g., a pressure sensitive adhesive (PSA) or other suitable means for gluing sandpaper to a plastic surface. In some embodiments, the sandpaper may be removably fixed to the sanding surface. For example, a suitable pressure sensitive adhesive that allows for the sandpaper to be removably adhered to without damaging the sanding surface may be use. In embodiments in which the sanding block is designed for use with a vacuum unit, the abrasive layer may be a porous sand-paper.

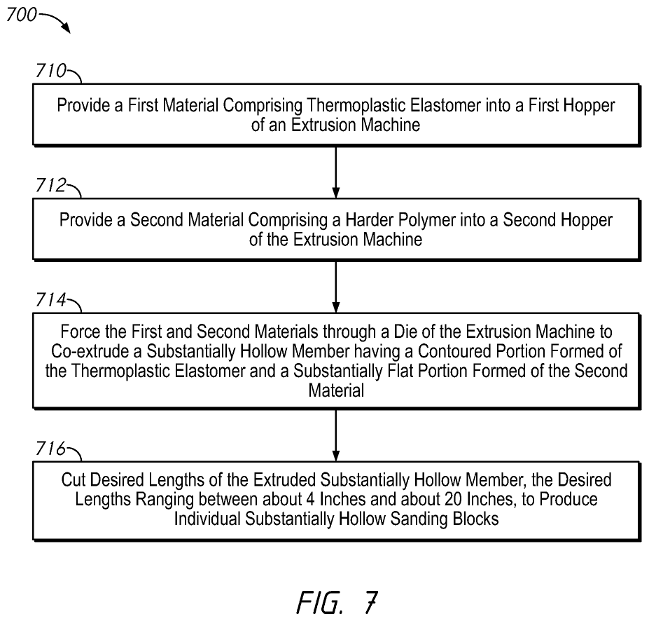

FIG. 7 shows a flow diagram of a process 700 for producing a sanding block according to further embodiments of the present disclosure. The process 700 shown in FIG. 7 may be used to implement, in part, step 612 of the process 600 in FIG. 6. Process 700 involves providing a supply of a first polymer, e.g., a thermoplastic elastomer, into a first hopper of an extrusion machine, as shown in step 710 and providing a supply of a second polymer harder than the first polymer, e.g. ABS or other acrylic, into a second hopper of the extrusion machine, as shown in step 712. The first and second polymers, which may be supplied into the respective chopper in pelletized form, are melted and forced through a die of the extrusion machine, as shown in step 714, to co-extrude the handle and base of a sanding block. The co-extrusion step produces a an extrusion member having a substantially hollow section and an outer profile suitable for use as a sanding block. That is, the outer profile of the extrusion member includes a contoured portion for the handle, which is made of the softer polymer, and a substantially flat portion for the base, which is made of a harder polymer, such as acrylic. Harder polymer is used for the base to provide not only the substantially smooth surface needed for the sanding surface but also a base that can apply sufficient pressure onto the work piece during use of the sanding block. In some embodiments, and depending on the thickness of the base, the base may flex to follow contours of the work piece while still being able to provide the necessary pressure to sand the finish surface of the work piece. Returning back to the process 700, the extruded member produced at step 714 is then cut to the desired length(s), e.g. ranging from about 4 inches to about 20 inches, in some cases no longer than about 12 inches, to produce the individual hollow sanding block(s), as shown in step 716. The individual hollow sanding blocks obtained at step 716, may be further processed by one or more of the subsequent steps (e.g., 612-618) of process 600, such as to produce a sanding block suitable for use with a vacuum unit.

The foregoing description has broad application. The discussion of any embodiment is meant only to be explanatory and is not intended to suggest that the scope of the disclosure, including the claims, is limited to these examples. In other words, while illustrative embodiments of the disclosure have been described in detail herein, the inventive concepts may be otherwise variously embodied and employed, and the appended claims are intended to be construed to include such variations, except as limited by the prior art.

The foregoing discussion has been presented for purposes of illustration and description and is not intended to limit the disclosure to the form or forms disclosed herein. For example, various features of the disclosure are grouped together in one or more aspects, embodiments, or configurations for the purpose of streamlining the disclosure. However, various features of the certain aspects, embodiments, or configurations of the disclosure may be combined in alternate aspects, embodiments, or configurations. Moreover, the following claims are hereby incorporated into this Detailed Description by this reference, with each claim standing on its own as a separate embodiment of the present disclosure.

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present disclosure, and do not create limitations, particularly as to the position, orientation, or use. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Identification references (e.g., primary, secondary, first, second, third, fourth, etc.) are not intended to connote importance or priority, but are used to distinguish one feature from another. The drawings are for purposes of illustration only and the dimensions, positions, order and relative sizes reflected in the drawings attached hereto may vary.

1. A sanding block comprising:
a handle body configured for an ergonomic fit in a user's hand, the body having a substantially constant cross-section along a full length of the handle body, wherein the handle body is a unitary body that defines all but one of a plurality of circumferential walls of an internal cavity defined by the sanding block, and wherein the handle body is made from a first polymeric material;
a base providing the one of the plurality of circumferential walls that encloses the internal cavity, wherein the base is made from a second polymeric material different from than the first polymeric material, and wherein the base has an externally facing surface that provides a smooth sanding surface of the sanding block; and
wherein the handle body and the base are formed and joined together via a co-extrusion process.

2. The sanding block of claim 1, wherein the cross-section of the handle body is defined by an outer extrusion surface defining, in part, an exterior of the sanding block and an inner extrusion surface defining, in part, the internal cavity, the inner extrusion surface substantially corresponding in profile to the outer extrusion surface.

3. The sanding block of claim 2, wherein the handle body has a substantially constant thickness as defined between the outer extrusion surface and the inner extrusion surface.

4. The sanding block of claim 2, wherein the thickness of the handle body is greater than a thickness of the base.

5. The sanding block of claim 1, wherein the first polymeric material is softer than the second polymeric material.

6. The sanding block of claim 5, wherein the first polymeric material is a thermoplastic elastomer.

7. The sanding block of claim 6, wherein the second polymeric material is an acrylic.

8. The sanding block of claim 1, wherein internal cavity is substantially sealed except for one or more inlet openings provided in the base, and one or more outlet openings provided in a handle formed at least in part by the handle body such that suction can be applied on the sanding block to draw air through the sanding block from the inlet to the outlet openings.

9. The sanding block of claim 1, further comprising a first plug fixed to the handle body and base proximate and sealing a first longitudinal side of the sanding block and a second plug fixed to the handle body and base proximate and sealing a second longitudinal side of the sanding block, whereby the internal cavity is substantially fully enclosed.

10. A method of manufacturing a sanding block comprising:
integrally forming a handle and a base, each formed of a different polymer having a different hardness, by co-extruding the different polymers to produce a sanding block;
fixing a first end wall to a first open longitudinal end of the sanding block thereby sealing the first open longitudinal end and a second end wall to a second open longitudinal end of the sanding block, thereby sealing an internal cavity of the sanding block;
drilling one or more inlet openings through the sanding surface and one or more outlet openings through a wall of the handle of the sanding block, whereby the internal cavity is provided in communication with ambient air;
securing respective one or more hose fittings to the one or more outlet openings in the handle; and
adhering an abrasive layer to the sanding surface.

11. The method of claim 10, wherein producing the sanding block comprises:
providing a supply of a thermoplastic elastomer into a first hopper of an extrusion machine;
providing a supply of a second polymer harder than the thermoplastic elastomer into a second hopper of the extrusion machine;
feeding the thermoplastic elastomer material into a contoured portion of a die of the extrusion machine while concurrently feeding the second material into a substantially flat portion of the die to co-extrude a extruded member;
cutting the extruded member into sanding blocks, each having a desired length ranging between 4 inches and 20 inches.

12. A sanding block produced by the method of claim 10.

13. A sanding block produced by simultaneously extruding, in a co-extrusion process, a first polymer and a second polymer which, when cured, is harder than the first polymer to produce an extrusion having a first wall formed of the first polymer and a second wall opposite the first wall and formed of the second polymer, the first and second walls spaced apart by a cavity defined therebetween during the co-extrusion process, the sanding block being further produced by cutting a segment from the extrusion and fixing an abrasive layer to an outer surface of the second wall.

14. A sanding block produced by the method of claim 11.
